(19) United States
(12) Patent Application Publication
(10) Pub. No.: US 2020/0298244 A1
(43) Pub. Date: Sep. 24, 2020

(54) GRINDING MILL

(71) Applicant: David Szego, Vaughan (CA)

(72) Inventor: David Szego, Vaughan (CA)

(21) Appl. No.: 16/360,467

(22) Filed: Mar. 21, 2019

(51) Int. Cl. B02C 15/08; B02C 15/00

(52) U.S. Cl. CPC B02C 15/08; B02C 2015/008; B02C 15/005

(57) ABSTRACT

The present invention relates generally to Szego-type grinding mills and in particular, to an improved Szego-type grinding mill incorporating interchangeable parts.

### FIELD OF THE INVENTION

The present specification relates generally to grinding mills and in particular, to an improved grinding mill incorporating interchangeable parts.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

A grinding mill known in certain academic circles as the Szego Mill was invented by Laszlo L. Szego in the 1960's, and granted Canadian Patent #974,956 issued Sep. 23, 1975 to General Comminution Inc. entitled “Ultrafine Pulverizer”. The mill was improved upon generally in Canadian Patent #1,068,662 issued Dec. 25, 1979 to General Comminution Inc. entitled “Comminution Device”, and further improved upon in Canadian Patent #1,134,336 issued Oct. 26, 1982 to General Comminution Inc. entitled “Multiple Stage Comminution Device”, and subtly further in Canadian Patent #1,249,986 “Method of Separating Solids by Simultaneous Comminution and Agglomeration”, issued Feb. 14, 1989.

The Szego Mill is a vertically oriented roller mill used for the comminuting and transporting of materials axially through the mill by an assembly of vertical rollers spinning inside a main vertical body cylinder of the mill, using centrifugal forces to push the rollers against the interior surface of the main body cylinder in order to effect a crushing force against particulate matter caught between the rollers and the interior surface. The rollers are helically lathed with a square-profile groove running down the length of the roller, which catches material and traverses it downwards in a screw movement.

In the Szego Mill, an effective comminution action is obtained on material which can be sheared into flakes such as mica or copper, or ground into granules such as other minerals, metals or food additives. However, research has found that pulpy fibrous material tends to shear into strands of a size not desirable for most commercial applications.

Additionally, the embodiments described in the previous patents have been found to cause a binding action due to the adhesion forces of the paste-like pulp material as it builds up in the grooves of the rollers due to the roller groove shapes described by the previous invention. This binding-up of material causes the rollers to stop their shearing action as friction against the inside wall of the main body cylinder of the Mill is reduced and the rollers begin to slip rather than rotate as the roller assembly spins inside the body.

Therefore, it would be desirable to modify Szego-type grinding mills in order to mitigate some of the disadvantages in the known art, and/or to produce additional benefits thereto.

Accordingly, there remains a need for improvements in the art.

### SUMMARY OF THE INVENTION

In accordance with an aspect of the invention, there is provided a material processing apparatus representing an improvement over existing Szego-type grinding mills by incorporating interchangeable parts.

According to an embodiment of the invention, there is provided a material processing apparatus comprising: a plurality of cylindrical rollers, each cylindrical roller having a central longitudinal axis and an outer surface, the axes of the rollers being vertical and nominally parallel to each other; a plurality of removable cylindrical sleeves, each cylindrical sleeve having a central longitudinal axis and an inner and outer surface, the inner surface of each sleeve conforming axially substantially to the outer surface of the rollers such that the sleeves can be slidably inserted over and removed from the rollers; a rotating assembly having an independent longitudinal axis and an upper and lower member to support and propel the plurality of rollers and sleeves freely around said independent axis; a plurality of mounts, each mount supporting additional longitudinal axes, with the rollers or sleeves attached or supported to the mounts within said rotating assembly; an inner hollow vertical cylindrical body having an inner and outer surface, into which the rotating assembly and rollers can be slidably inserted and removed; an outer hollow vertical cylindrical body having an inner surface conforming axially substantially to the outer surface of the inner cylindrical body, into which the inner body or said rotating assembly can be slidably inserted and removed; a drive member for turning said rotating assembly within the outer and inner bodies; a base on which to mount the outer and inner bodies; and a frame on which to mount the base.

According to a further embodiment of the invention, there is provided a method of processing materials, comprising: inserting material particles, each particle having a minimum and maximum size into a processing apparatus, the processing apparatus comprising: a plurality of cylindrical rollers, each cylindrical roller having a central longitudinal axis and an outer surface, the axes of said rollers being vertical and nominally parallel to each other; a plurality of removable cylindrical sleeves, each cylindrical sleeve having a central longitudinal axis and an inner and outer surface, said inner surface conforming axially substantially to the outer surface of said cylindrical rollers such that said sleeves can be slidably inserted over and removed from said rollers; a rotating assembly having an independent longitudinal axis and an upper and lower member to support and propel said plurality of rollers and sleeves freely around said independent axis; a plurality of mounts, each mount supporting additional longitudinal axes whereby said rollers or sleeves are attached or supported within said rotating assembly; an inner hollow vertical cylindrical body having an inner and outer surface, into which said rotating assembly and rollers can be slidably inserted and removed; an outer hollow vertical cylindrical body having an inner surface conforming axially substantially to the outer surface of said inner cylindrical body, into which said inner body or said rotating assembly can be slidably inserted and removed; a drive member for turning said rotating assembly within said bodies; a base on which to mount said bodies; and a frame on which to mount said base; processing the material particles in the apparatus, and extracting the processed material particles from the apparatus.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a top view used for reference of the original device as shown in Canadian Patent #974,956 showing an assembly of three grinding rollers mounted by a wire rope on three individual arms, the entire assembly rotating on a central shaft inside a cylindrical grinding body;

FIG. 2 is a perspective view of the roller assembly of FIG. 1 of a Szego Mill, with a square-profile helical groove lathed axially along the length of the roller, and held by an upper and lower roller mounting plate, as shown in Canadian Patent #1,249,986;

FIG. 3 is a schematic profile view, partly in section, showing an embodiment of the present invention, as an improvement to the rollers of FIGS. 1-2;

FIG. 4 is a sectional rendering of the FIG. 3 device, showing an embodiment of the present invention, as an improvement to the rollers of FIGS. 1-2;

FIG. 5 is a representative drawing showing the improvements of additional comminuting actions effected by the roller device of FIGS. 3-4 onto fibrous or other material as it rotates, and improvements in ejection of material;

FIG. 6 is an alternate embodiment of the device of FIGS. 3-5 having a rigid mounting in accordance with the present invention, as an improvement to the rollers of FIGS. 1-2;

FIG. 7 is an alternate embodiment of the sliding mount guide on the end of the shaft of the FIG. 6 device.

FIG. 8 is an alternate embodiment of the roller of the FIG. 6 device, said roller having a taper from a midpoint towards the upper edge.

FIG. 9 is an internal view of the FIG. 6 device, showing the mounting of the roller of FIGS. 3-8, as an improvement to the rollers of FIGS. 1-2;

FIGS. 10-14 are top views of various embodiments of the mounting of a plurality of the rollers of FIGS. 3-9 in an assembly of FIG. 6 devices for rotation on a central shaft inside a cylindrical body, as an improvement to the rollers and assemblies of FIGS. 1-2;

and

FIGS. 15-22 are cutaway views showing a number of alternate embodiments of the cylindrical bodies in which the FIGS. 10-14 assemblies rotate, as an improvement to the cylindrical body of FIG. 1.

Like reference numerals indicate like or corresponding elements in the drawings.

### DETAILED DESCRIPTION OF THE EMBODIMENTS

The present invention relates generally to Szego-type grinding mills and in particular, to an improved Szego-type grinding mill incorporating interchangeable parts.

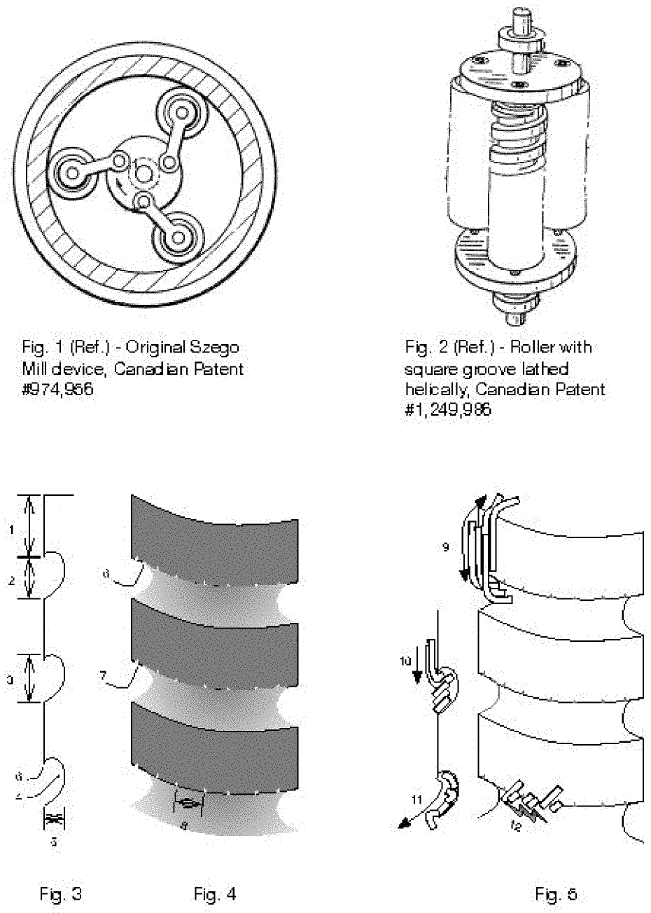

Reference is first made to FIG. 1, which shows the original Szego Mill of Canadian Patent No. 974,956 having a cylindrical grinding body. The body has an interior surface which is vertically parallel and symmetrical about the central axis of the device. A central axle is provided, from which the grinding rollers are held and impart their force centrifugally upon the interior surface. Reference is further made to FIG. 2, which shows a profile of a grinding roller as a cylinder in which a square-profile helical groove is lathed axially along the length of the roller from Canadian Patent No. 1,249,986.

In the general use of the Szego Mill, coarse particulate material is fed from the top as the internal assembly rotates at high speed. This causes the rollers to spin in the opposite direction of the assembly due to their friction against the interior surface of the grinding body. When the material is of an oily or sticky nature, as is often the case with organic material such as grains, seeds, and wood or paper pulp, the material tends to bind within the grooves of the rollers. This is due to the build-up of pulverized material against the interior surface of the grinding body, causing the grinding rollers shown in FIGS. 1 & 2 to be pushed by their outermost faces to the limit of their movement inwards towards the central axis of the machine. The roller binds on the wire rope axle described in the original patents, causing damage to the roller. This in turn causes slippage of the rollers due to the lack of friction against the oily material, and further material is then only able to move into the groove areas. Without centrifugal forces acting upon the material, it cannot overcome the adhesion forces and is not ejected from the grooves.

Referring now to FIG. 3, an embodiment of the present invention shows an improved groove profile for lathing a helical groove into the cutting roller, in that the groove is curved (4), not polygonal. The curve can be described as having a height (3) extending from the top edge of a lower face extending up beyond the lower edge of an upper face, and a depth (5) into the body of the roller from the outer face (1) towards its central axis. The depth profile moves upwards and inwards in a somewhat logarithmic spiral towards the highest point of the groove height, then back downwards and outwards towards the bottom edge of the upper face. The resulting shape is similar to the symmetrical half of a commonly-drawn “heart”, This causes a knife-edge shape (6) to be made from the lower edge of the upper face, and a smoothly curved surface flowing outwards towards the bottom of the helical lathing. This profile is then polished for smoothness.

FIG. 4 shows a rendering of the curve in which can be seen notches (7) cut into the knife-edge (6), at various spacings (8). Other features of these notches will be described below.

FIG. 5 describes a number of actions of the roller during its rotation, including a centrifugal ejection of material (11) from the groove. As the roller is spun at operating speed, material caught or pushed into the groove (9-11) is acted on by a much stronger centrifugal force than with the square or polygonal grooves of previous inventions. The gullet of the curve, having no corners or angles, allows much less packing of material than a polygonal shape. Even with typical adhesion forces of oily material, the material will be prone to sliding downwards due to the momentum of the driving force of the helical groove (rotating as a downward screw) and outwards as it follows the smoothness of the curve towards the ejection point of the material, at the lowest point of the curve where the material once again meets the interior surface of the cylindrical body—refer to (11).

An additional cause of the binding problem inherent in the use of oily or sticky materials in the mill is the limited comminution actions acted upon the material. In the previous invention, material is flattened against the interior surface by the face of the roller. Because certain materials are softer than they are brittle, they tend to be spread flat and “squished” rather than crushed, adding to the packed smoothness of the material against the interior surface and contributing to the slippage of the roller. This is shown in FIG. 5 as a shearing action (9) in the direction of the arrows. The material is then pushed down into the groove due to the downwards screw motion of the roller, as shown by the curve of the material in the diagram.

By lathing the roller with the profile (4) described above, the knife-edge (6) which is created pushes down through the material brought into the groove, cutting it and separating the cut portion from the fibre or flattened material still remaining between the interior surface and the roller—refer to (10), showing a knife-edge cutting action in the direction of the arrow. This cutting action now adds a second comminution action to be acted upon the material in the mill, that of cutting (10) in addition to shearing (9).

As the roller now has a fine knife-edge helically along it's body, a third comminution action can be created by creating nicks or notches of various sizes and shapes (7) at regular or irregular intervals (8) along the knife edge (6). The sections (8) of the knife-edge (6) between the notches (7) become teeth as in a ceramic cutting disc, spaced as widely or narrowly (8) as needed for a given application. These notches catch material as it is pulled into the groove, causing a third comminution action to be acted upon material in the mill, that of ripping of fibres or other types of material into shorter lengths, shown in (12) as a tooth-notch ripping action.

The presently described roller is now capable of crushing, shearing (9), cutting (10) and ripping (12) material while reducing binding of material in the roller and actively assisting in its ejection from the roller (11) so as to prevent slippage.

In order that material which does inevitably remain in the grooves be easily cleaned, and to facilitate quick removal, maintenance, and exchange of rollers of different sizes and profiles for use in the same mill unit, the present invention further provides embodiments to act as an improvement to the mounting of the grinding rollers over the known references (see FIGS. 1-2).

Whereas the original Szego Mill design of FIG. 1 shows three rollers permanently mounted on swing-arms to a central mounting disc, with the patent describing a flexible wire rope as the axle of the roller, a later improvement shown in FIG. 2 has the rollers permanently mounted directly on the mounting disc (the arms are no longer present), with the rollers held in place vertically by the mounting discs at top and bottom, and axially by a flexible shaft around which the roller floats in order to move laterally as the assembly spins.

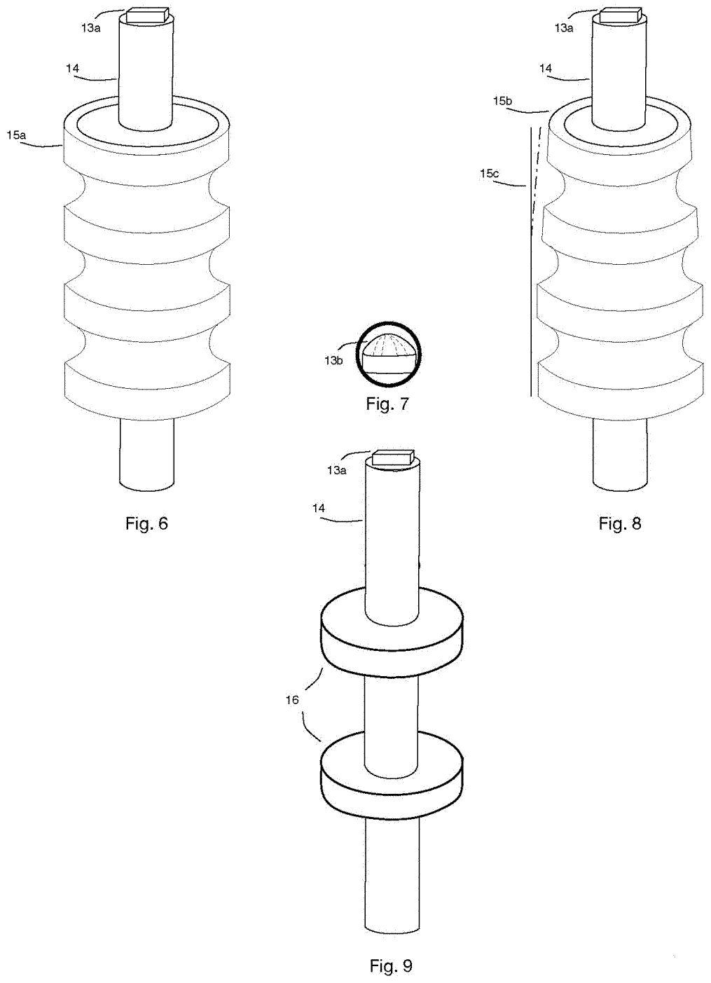

FIG. 6 shows an embodiment of the improved roller of the present invention (15a) mounted on a solid cylindrical shaft (14) having a rectangular (13a), convex (13b in FIG. 7), or similar profile cut from the shaft at top and bottom, acting as a sliding mount guide to be inserted in a suitable groove or slot (18a/b), described below.

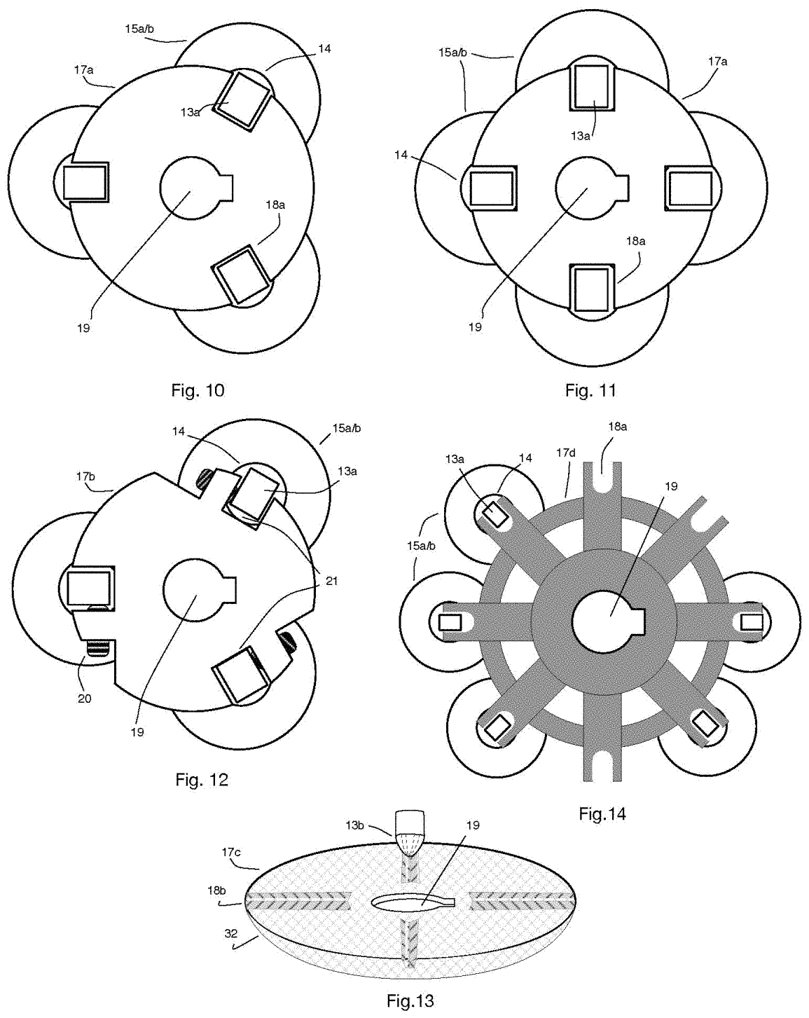

FIG. 7 shows an embodiment (13b) of the sliding mount guide (13a) of FIG. 6, whereby the convex rounded ends of the shaft engage in a matching concave groove (18b) of FIG. 13, at a depth which holds the shaft captive in one direction perpendicular to the groove length, but allows movement laterally across the groove thus sliding towards the interior grinding surface of the mill as centrifugal forces increase. The shaft (14) of the roller assembly (15a/b) of FIGS. 6-9 is thus limited in its travel inwardly by the stopped end of the groove and outwardly by the interior grinding surface, yet the roller assembly is easily removed when the entire assembly of FIGS. 10-14 is lifted out of the mill, as there is no longer an outward limit.

Associated to FIG. 7 is an embodiment (17c) of the roller mounting assembly shown in FIG. 13. This embodiment again allows easy replacement, cleaning, and maintenance while potentially allowing more efficient mounting assembly manufacture, be it by 3D printing of a honeycomb matrix mesh (as shown by the patterning in FIG. 13), or by lessened overall thickness of the disc by tapering towards the outer edge (32), due to downwards force of the roller being placed directly on the face of the disc, such force being transferred inwards towards the thicker center of the disc by the shape of the taper of the bottom face.

FIG. 8 shows an embodiment of the improved roller (15b) of the present invention mounted similarly to (15a) of FIG. 6, whereby the roller tapers from a midpoint inwards towards the top in order to effect a larger gap between the roller face (1) and the interior wall of the grinding body (24) or grinding sleeve (26) (both described below). This presents a method whereby the maximum particle size of material accepted by the mill can be increased to suit the size of the gap at the upper limit of the taper, as the material will be reduced as it traverses downwards along the roller in increasing proximity to the grinding surface. As rollers are easily interchanged in the present invention of a modular mill system, this embodiment of the roller shape presents a method and mechanical elements for allowing flexible particle size maxima as best suits the grinding operation requirements.

FIG. 9 shows the internal assembly of the roller mount, having two ball bearings (16) mounted around the shaft (14) over which the roller itself (15a/b) slides so that the roller spins on the outer race of the ball bearing while the shaft spins in the inner race. This improves upon the design of the original roller of FIGS. 1-2 by allowing for removal and replacement of the roller without need for replacing the shaft itself and without special tools, a much more economical and easily maintainable solution. For longer rollers a plurality of bearings (16) may be employed on a longer shaft (14) as necessary.

FIGS. 10-14 show a number of possible embodiments of an improved mounting disc (17a-d) (ref. FIG. 2 for comparison) in which the sliding mount guide (13a) is inserted in a mounting slot (18a) cut into the disc (17a, b, d) circumferentially at 120° in order to accommodate three rollers (FIG. 10), or at 90° (FIG. 11) in order to accommodate four rollers. Multiple rollers may be incorporated in alternate embodiments by reducing the angle and adjusting the diameter of the disc or roller to fit, such as an additional possible embodiment of a mounting disc (17d) accommodating multiple rollers, shown in FIG. 14. One mounting disc is necessary at each the top and bottom of the overall assembly, similarly to FIG. 2.

The open-ended mounting slot (18a), cut slightly wider than the sliding mount guide (13a), allows the roller-and-shaft assembly of FIGS. 6 and 8 to float laterally in order to exert outward pressure against the interior surface of the grinding body by the centrifugal force of the rotation of the assembly, and thus enact comminution of the material in the mill.

Similarly, FIG. 13 shows an alternate embodiment of the roller mounting body (17c) using an alternate embodiment of the mounting slot (18b) whereby the slot is now a diagonal or concave carving in the Z plane of the surface of the roller mounting body, made to fit an alternate embodiment of the roller shaft sliding mount guide, (13b, shown in FIG. 7). This embodiment uses a convex rounded end of the shaft to fit into the slot and freely slide in a lateral fashion with the centrifugal forces present during mill operation. The shaft end and groove (13b and 18b) would be of sufficient depth to hold the roller shaft (14) within the groove.

By not keeping the roller-and-shaft assembly of FIGS. 6 and 8 firmly captive in the mounting assembly of FIG. 10 et. al., the rollers are easily removed for maintenance, exchange, or cleaning. This is a significant productivity improvement (resulting in time and cost savings) over the original Szego Mill designs which require complex disassembly using tools.

FIG. 12 shows an alternate embodiment of the roller mounting assembly (17b) in which the rollers are held at a fixed distance from the centre of the mounting assembly (19) by a set screw (20) or other locking mechanism, giving an adjustable gap (21) between the sliding mount guide (13a/b) and the innermost surface of the mounting slots (18a). This allows specific fine control of the particle size by limiting the pressure of the rollers against the interior surface of the grinding body while not impairing the rotational ability of the roller. Material would only be ground as coarse as allowed by the resulting gap between the roller face and the interior surface of the grinding body.

An additional issue with the design of the original Szego Mill which has been discovered over time is that certain conditions within the mill cause rollers to bind, thereby scraping against the interior surface of the grinding body rather than freely rotating as the overall assembly of rollers spins. This causes wear spots on the bound roller. It would be theoretically possibly to encounter this same condition with the fixed-shaft roller mounting of FIG. 12, if the roller were pressed too firmly against the interior surface of the grinding body, or due to the rollers no longer being allowed to move inwards to accommodate larger particles.

A potential added benefit of the improvement shown earlier in FIG. 9 is that by using ball bearings (16) encased in rubber (readily available), the roller has some play laterally with which to overcome larger sized particles that may otherwise cause this binding.

As described earlier, alternate methods of holding such rollers, such as the example of a wagon-wheel shape shown in FIG. 14, would allow increased numbers of rollers for scale-up of internal grinding body diameter, while maintaining strength and keeping overall weight as low as possible.

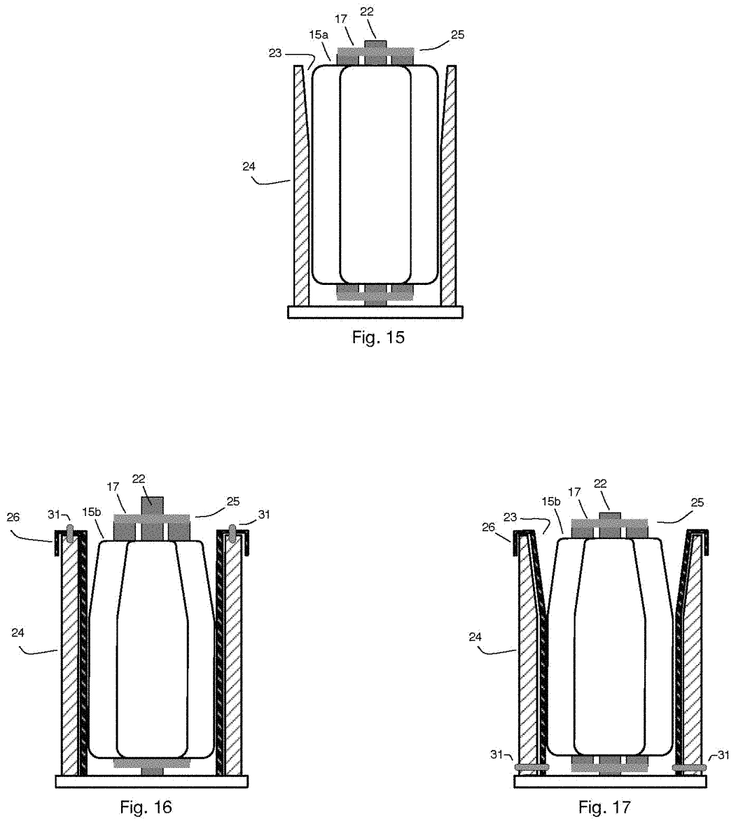

The entire roller assembly of FIGS. 6-14 (referred to as (25) in FIGS. 15-21) is held on a central shaft (referred to as (22) in FIGS. 15-21) which traverses the mounting assembly (17a-d) through a hole and locking key (19).

Thus, the combinations of improvements as shown in FIGS. 6-14 create an entirely new structure of the roller internals of the grinding mill, having the added flexibility over the previous design of controllable particle size combined with a lessened overall risk of damage to the rollers, and easier, more economic cleaning and maintenance via the use of interchangeable parts.

FIGS. 15-22 show a series of improvements to the grinding body of the previous patents (compare with FIG. 1). FIG. 15 describes a tapering (23) of the upper portion of the interior surface of the grinding body (24) until a specific taper limit, at which point the grinding body walls become parallel. This tapering section allows the mill to accommodate larger particles. Contrast with the earlier description of (15c) in FIG. 8, which is the inverse of this embodiment, enacted in the roller rather than the body—although these two embodiments can be combined for very large particles. These particles would have contact with the rollers only as they fall to a point whereby the width of the particle is equal to the distance between the interior surface of the grinding body and the grinding face of the roller, at which point a comminuting action would be effected upon the particle allowing it to fall lower until ultimately the particle is at a sufficient fineness to be permitted transport below the taper limit and traverse the remaining distance of the roller.

FIG. 16 shows an embodiment of the main body of the mill which is an improvement to the modularity and flexiblity of the mill by enabling a removable or exchangeable cylindrical grinding sleeve (26) to be inserted into the grinding body (24). This sleeve can be made of various materials such as tungsten carbide, manganese steel, ceramic or ceramic-metal alloys, or other materials as suited to the specific hardness or roughness needs of the grinding application. The sleeve would be locked from rotating by a set-pin (31) or any similar mechanism so as not to rotate within the grinding body by the friction induced by the rollers.

FIG. 17 shows an alternate embodiment of an inner cylindrical grinding sleeve (26), tapered to match the taper (23) of the grinding body described in FIG. 15 in order to achieve a proper fit.

The use of an inner grinding sleeve (26) removes the need for the grinding body (24) to be made from hardened steel, and to be made as thick as would need be without a sleeve, as the main grinding body is now acting merely as a support body and not as a surface which will be worn from pressure and abrasion. This allows the main body to be built from a cheaper metal, alternately 3D printed, alternately made of a plastic matrix network having enhanced stability and rigidity, alternately being made of a metal which better transfers heat from the sleeve, or any combination of such techniques. This significantly reduces manufacturing cost of the mill, an improvement over the previous patents allowing a modular grinding body system suited to the economics of the required mill specifications.

When grinding material with a sensitivity to heat, such as rubber, certain plastics, food additives, grains or other foods, or certain other materials, the heat induced by the friction of the grinding rollers can alter the structure and substance of the material being ground. This can adversely affect the quality of the material including its capability to be comminuted at all. The grinding body of the previous patents, being made of hardened steel, is not an effective conductor of heat away from the grinding body and material, even when contained in a cooling sheath.

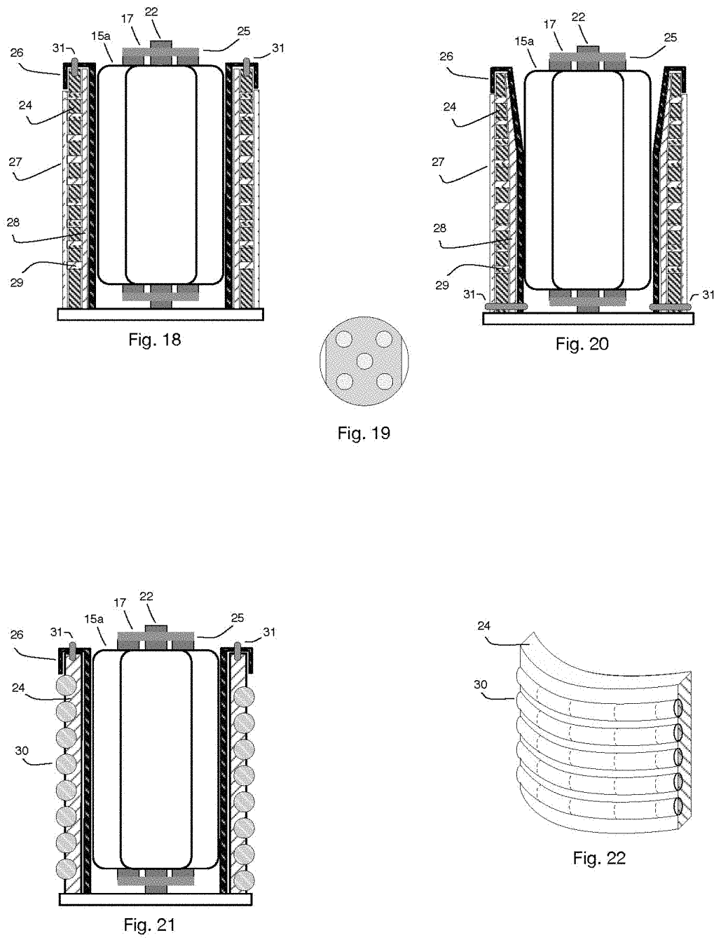

FIGS. 18-20 show an alternate embodiment of the grinding body, made possible by the use of the inner cylindrical grinding sleeve (26) introduced in FIG. 16, whereby the grinding body (24) is mated with an inner (28) and outer (27) copper cylinder or other effective heat-conducting material, each of a thickness sufficient to absorb a significant amount of heat. The inner and outer cylinders are joined through the rigid cylindrical body (24) by a pattern of holes drilled in the rigid body and filled with copper slugs (29) or other effective heat conducting material, shown in face view in FIG. 19.

In an alternate embodiment of the grinding body described above, the grinding body (24) may be manufactured using an aluminum honeycomb cylinder, 3D-printed plastic matrix, or other cheaper materials and methods acting as the supporting basis for placement of slugs (29) which would act as the structural strength and heat transferring portion of the body between surfaces (27-28).

FIG. 20 shows an alternate embodiment of the cooling sheath assembly of FIG. 18 which is fitted to match the taper of the inner tapered cylindrical grinding sleeve of FIGS. 15 and 17. FIGS. 21-22 show an alternate embodiment of the cooling assembly of FIGS. 18-20 whereby the cooling is effected by a coil of tubing (30) countersunk into a mating lathed profile in the main body (24) and wrapped helically around the body, through which a heat-transfer fluid such as water, Freon, liquid nitrogen, propylene glycol, or other coolant may be circulated. The coil is shown around a body in which a grinding sleeve (26) is inserted, but may also be used without a sleeve so long as the thickness of the body (24) remains sufficient for support when lathed with the mating profile. FIG. 22 shows a cutaway view of the cylindrical body (24) with turns of the cooling coil (30) wrapped tightly around it, into the lathed mating profile.

The embodiment of FIGS. 21-22 provides a more economical manufacturing alternative to the embodiment of FIGS. 18-20, with different cooling properties as may be desired for the specific needs of a given grinding application.

The entire set of combinations of multi-layer body assembly of FIGS. 16-17, consisting of a main rigid body (24) and an inner grinding sleeve (26); or FIGS. 18-20, consisting of an outer cooling cylinder, an inner rigid cylinder (which no longer requires the costs of hardening), an inner cooling cylinder, and an inner grinding cylinder made of appropriate material for acting as a grinding surface, all cylinders being fitted concentrically in the order described, may now be housed in a further outer cylinder acting as a cooling sheath for liquid or gas circulation. The same applies to the use of an alternate grinding body wrapped in cooling coil of FIGS. 21-22 rather than inner and outer mated cooling cylinders; or to the singular grinding body of FIG. 15.

The various embodiments of the present invention of a modular grinding roller assembly of FIGS. 3-9, mounted in an embodiment of a modular roller mounting assembly of FIGS. 10-14, and inserted in one or more concentrically assembled cylindrical bodies for rotation against the interior surface of a straight or tapered rigid grinding body or grinding sleeve of FIGS. 15-22, cooled as necessary by either of the cooling systems described, may allow complete modularity for all desired components of the mill: roller, roller mount, grinding body, optional inner sleeve, and optional cooling system.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for design, assembly and use of Szego-type grinding machines are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A material processing apparatus comprising:
a plurality of cylindrical rollers, each cylindrical roller having a central longitudinal axis and an outer surface, the axes of the rollers being vertical and nominally parallel to each other;
a plurality of removable cylindrical sleeves, each cylindrical sleeve having a central longitudinal axis and an inner and outer surface, the inner surface of each sleeve conforming axially substantially to the outer surface of the rollers such that the sleeves can be slidably inserted over and removed from the rollers;
a rotating assembly having an independent longitudinal axis and an upper and lower member to support and propel the plurality of rollers and sleeves freely around said independent axis;
a plurality of mounts, each mount supporting additional longitudinal axes, with the rollers or sleeves attached or supported to the mounts within said rotating assembly;
an inner hollow vertical cylindrical body having an inner and outer surface, into which the rotating assembly and rollers can be slidably inserted and removed;
an outer hollow vertical cylindrical body having an inner surface conforming axially substantially to the outer surface of the inner cylindrical body, into which the inner body or said rotating assembly can be slidably inserted and removed;
a drive member for turning said rotating assembly within the outer and inner bodies;
a base on which to mount the outer and inner bodies; and
a frame on which to mount the base.

2. The apparatus according to claim 1, wherein the rollers, the sleeves, the inner body and the outer body are each made from one or more of: a steel alloy, a hardened steel alloy, tungsten, a tungsten alloy, a non-ferrous metal alloy, a rubberized compound, a ceramic, and a ceramic metal alloy.

3. The apparatus according to claim 1, wherein one or more of the rollers, the sleeves, the inner body and the outer body are coated with a layer of material to provide a specific desired hardness, the material being one or more of: tungsten carbide, ceramic, ceramic metal alloy and a chemical oxide.

4. The apparatus according to claim 1, further including modifying the outer body such that the outer body conducts heat away from the inner body, the modifications including one or more of:
forming the outer body from a heat conducting material, the heat conducting material comprising one or more of: copper and a copper alloy;
drilling holes in the outer body;
inserting a wall of heating conducting material between the outer body and the inner body connecting the inner body and the outer body, the heat conducting material being one or more of: copper and a copper alloy; and
wrapping a coil of heat-conductive tubing around the outer body.

5. The apparatus according to claim 4, wherein the holes drilled in the outer body are filled with a conductive material, the conductive material being one of: an inserted slug of metal, cast metal and poured metal.

6. The apparatus according to claim 4, wherein the heat-conductive tubing further includes a circulating fluid within the tubing, the fluid including one or more of: Freon, water, liquid nitrogen, propylene glycol and helium.

7. The apparatus according to claim 1, wherein the outer surface of one of the rollers and the sleeve has a thread and groove structure running spirally around the outer surface.

8. The apparatus according to claim 7, wherein the thread and groove structured is defined by one or more of: a flat-faced structure, two or more concentric flat-faced structures, a helically wound coil, an engraved acme profile, an engraved trapezoidal profile, an engraved curved profile, an engraved rounded profile, a logarithmic curve profile and a parabolic curve profile.

9. The apparatus according to claim 7, wherein the thread and groove profile includes one or more of: a knife edge on the thread profile protruding over the groove, a series of regularly spaced notches along the thread, and a series of irregularly spaced notches along the thread.

10. The apparatus according to claim 1, further including one or more rotational members disposed around the longitudinal axis of the mounts such that the roller freely rotates around the rotational member.

11. The apparatus according to claim 10, further including shock-absorbing padding surround the rotational members.

12. The apparatus according to claim 1, wherein the upper member and lower member of the rotating assembly are each formed as one of: a solid plate, a hub-and-spoke wheel, a set of radially extending arms, and a partially hollow wheel.

13. The apparatus according to claim 1, wherein the rollers and the sleeves each have one of: a smooth outer surface, a fine textured outer surface and a rough textured outer surface.

14. The apparatus according to claim 1, wherein at least one of the rollers, the sleeves, the inner body and the outer body have a varying diameter decreasing from a maximum diameter at a fixed point midway along the longitudinal axis towards one end of the cylinder to a minimum diameter at the one end of the cylinder.

15. The apparatus according to claim 1, wherein the rollers and the sleeves are loosely coupled to the rotating assembly such that replacement of the rollers and the sleeves is accomplished with minimal tool use.

16. A method of processing materials, comprising:
inserting material particles, each particle having a minimum and maximum size into a processing apparatus, the processing apparatus comprising:
a plurality of cylindrical rollers, each cylindrical roller having a central longitudinal axis and an outer surface, the axes of said rollers being vertical and nominally parallel to each other;
a plurality of removable cylindrical sleeves, each cylindrical sleeve having a central longitudinal axis and an inner and outer surface, said inner surface conforming axially substantially to the outer surface of said cylindrical rollers such that said sleeves can be slidably inserted over and removed from said rollers;
a rotating assembly having an independent longitudinal axis and an upper and lower member to support and propel said plurality of rollers and sleeves freely around said independent axis;
a plurality of mounts, each mount supporting additional longitudinal axes whereby said rollers or sleeves are attached or supported within said rotating assembly;
an inner hollow vertical cylindrical body having an inner and outer surface, into which said rotating assembly and rollers can be slidably inserted and removed;
an outer hollow vertical cylindrical body having an inner surface conforming axially substantially to the outer surface of said inner cylindrical body, into which said inner body or said rotating assembly can be slidably inserted and removed;
a drive member for turning said rotating assembly within said bodies;
a base on which to mount said bodies; and
a frame on which to mount said base;
processing the material particles in the apparatus, and
extracting the processed material particles from the apparatus.

17. The method of claim 16, further including configuring the apparatus for the materials being processed wherein the rollers, the sleeves, the inner body and the outer body are each made from one or more of: a steel alloy, a hardened steel alloy, tungsten, a tungsten alloy, a non-ferrous metal alloy, a rubberized compound, a ceramic, and a ceramic metal alloy.

18. The method of claim 16, further including configuring the apparatus for the materials being processed wherein one or more of the rollers, the sleeves, the inner body and the outer body are coated with a layer of material to provide a specific desired hardness, the material being one or more of: tungsten carbide, ceramic, ceramic metal alloy and a chemical oxide.

19. The method of claim 16, further including adding a thread and groove profile to the rollers of the apparatus.

20. The method of claim 19, further including adding a knife edge and/or one or more notches to the thread and groove.

21. The method of claim 16, further including replacing the sleeves with alternate sleeve of different diameter and shape according to the material being processed.

22. The method of claim 19, further including replacing the sleeves with alternate sleeves having a different thread and groove pattern according to the material being processed.

23. The method of claim 16, wherein at least one of the rollers, the sleeves, the inner body and the outer body have a varying diameter decreasing from a maximum diameter at a fixed point midway along the longitudinal axis towards one end of the cylinder to a minimum diameter at the one end of the cylinder.

24. The method of claim 16, further including loosely coupling the rollers and the sleeves to the rotating assembly such that replacement of the rollers and the sleeves is accomplished with minimal tool use.
